(19) United States
(12) Patent Application Publication
(10) Pub. No.: US 2025/0293244 A1
(43) Pub. Date: Sep. 18, 2025

(54) NEGATIVE ACTIVE MATERIAL, METHOD OF PREPARING SAME, NEGATIVE ELECTRODE INCLUDING SAME, AND RECHARGEABLE LITHIUM BATTERY INCLUDING SAME

(71) Applicant: SAMSUNG SDI CO., LTD., Yongin-si (KR)

(72) Inventors: Joongho MOON, Yongin-si (KR); Seyoung OH, Yongin-si (KR); Soonbong CHOI, Yongin-si (KR)

(21) Appl. No.: 19/070,004

(22) Filed: Mar. 4, 2025

(30) Foreign Application Priority Data
Mar. 14, 2024 (KR) 10-2024-0035908

(51) Int. Cl. H01M 4/36; C01B 32/205; H01M 4/02; H01M 4/587; H01M 10/052

(52) U.S. Cl. CPC H01M 4/366; C01B 32/205; H01M 4/364; H01M 4/587; H01M 10/052; C01P 2002/74; C01P 2004/03; C01P 2004/32; C01P 2004/50; C01P 2004/54; C01P 2004/61; C01P 2006/40; H01M 2004/021; H01M 2004/027

(57) ABSTRACT

A negative active material, a method of preparing the same, a negative electrode including the same, and a rechargeable lithium battery including the same are provided. The negative active material has a peak intensity ratio (I₍₁₁₀₎/I₍₀₀₂₎) of a peak intensity at a (110) plane relative to a peak intensity at a (002) plane of about 30 to about 70, as measured by X-ray diffraction using a CuKα ray, and including an aggregate where spherical graphite and non-spherical artificial graphite are aggregated (e.g., agglomerated).

### CROSS-REFERENCE TO RELATED APPLICATION

The present application claims priority to and the benefit of Korean Patent Application No. 10-2024-0035908, filed in the Korean Intellectual Property Office on Mar. 14, 2024, the entire content of which is incorporated herein by reference.

### BACKGROUND

### 1. Field

Embodiments relate to a negative active material, a method of preparing the negative active material, a negative electrode including the negative active material, and a rechargeable lithium battery including the negative electrode.

### 2. Description of the Related Art

Recently, with the rapid spread of electronic devices that use batteries, e.g., mobile phones, laptop computers, and/or electric vehicles, a demand or desire for smaller, lighter and relatively high-capacity batteries, e.g., rechargeable lithium batteries is rapidly increasing. A rechargeable lithium battery has recently drawn attention as a driving power source for portable devices, as it has lighter weight and high energy density as compared to other comparable batteries. Improving performances of rechargeable lithium batteries has been considered and pursued.

A rechargeable lithium battery includes a positive electrode and a negative electrode, each including an active material capable of intercalating and deintercalating lithium ions, and an electrolyte solution. Electrical energy is produced by oxidation and reduction reactions if (e.g., when) lithium ions are intercalated/deintercalated at the positive and negative electrodes.

### SUMMARY

An aspect according to one or more embodiments is directed toward a negative active material exhibiting excellent or suitable electrochemical characteristics.

An aspect according to one or more embodiments is directed toward a method of preparing the negative active material.

An aspect according to one or more embodiments is directed toward a negative electrode including the negative active material.

An aspect according to one or more embodiments is directed toward a rechargeable lithium battery including the negative electrode.

Additional aspects will be set forth in part in the description which follows and, in part, will be apparent from the description, or may be learned by practice of the presented embodiments of the disclosure.

According to one or more embodiments, a negative active material includes an aggregate where spherical artificial graphite and non-spherical artificial graphite are aggregated (e.g., agglomerated), and has a peak intensity ratio (I₍₁₁₀₎/I₍₀₀₂₎) of a peak intensity at a (110) plane relative to a peak intensity at a (002) plane of about 30 to about 70, as measured by X-ray diffraction using a CuKα ray.

According to one or more embodiments, a negative electrode includes a negative active material layer, the negative active material layer including a negative active material including an aggregate where spherical artificial graphite and non-spherical artificial graphite are aggregated (e.g., agglomerated), wherein the negative electrode has a peak intensity ratio (I₍₁₁₀₎/I₍₀₀₂₎) of a peak intensity at a (110) plane relative to a peak intensity at a (002) plane of about 200 to about 1000, as measured by an X-ray diffraction using CuKα ray.

According to one or more embodiments, a method of preparing the negative active material includes mixing a carbon precursor for a spherical artificial graphite and non-spherical artificial graphite to form a mixture, aggregating the mixture to form a product; and graphitizing the product.

According to one or more embodiments, a rechargeable lithium battery includes a negative electrode including the negative active material, a positive electrode, and an electrolyte.

According to one or more embodiments, a rechargeable lithium battery includes the negative electrode; a positive electrode, and an electrolyte.

The negative active material according to one or more embodiments may exhibit excellent or suitable electrochemical characteristics.

### BRIEF DESCRIPTION OF THE DRAWINGS

The above and other aspects, features, and enhancements of certain embodiments of the disclosure will be more apparent from the following description taken in conjunction with the accompanying drawings, in which:

FIG. 1 is a schematic illustration of the negative active material according to one or more embodiments.

FIG. 2 is a schematic illustration of the rod-shaped artificial graphite according to one or more embodiments.

FIG. 3 is a diagram schematically showing a cylindrical rechargeable lithium battery according to one or more embodiments of the present disclosure.

FIG. 4 is a schematic cross-sectional view of a prismatic battery according to one or more embodiments of the present disclosure.

FIG. 5 is a schematic illustration of a pouch-type battery according to one or more embodiments of the present disclosure.

FIG. 6 is a schematic illustration of a pouch-type battery according to one or more embodiments of the present disclosure.

FIG. 7 is a scanning electron microscope (SEM) image of the negative active material prepared by Example 1.

FIG. 8 is an SEM image of the negative active material prepared by Comparative Example 2.

FIG. 9 is an SEM image of the negative active material prepared by Comparative Example 1.

### DETAILED DESCRIPTION

Hereinafter, embodiments are described in more detail. However, these embodiments are examples, and the present disclosure is not limited thereto and the scope of the present disclosure is defined by the claims and equivalents thereof.

As used herein, if (e.g., when) a definition is not otherwise provided, it will be understood that if (e.g., when) an element such as a layer, film, region, or substrate is referred to as being “on” another element, it may be directly on the other element or intervening element(s) may also be present.

Unless otherwise specified in the specification, expressions in the singular include expressions in plural. Unless otherwise specified, “A or B” may indicate “includes A, includes B, or includes A and B”.

As used herein, the term “combination thereof” may include a mixture, a laminate, a complex, a copolymer, an alloy, a blend, and/or a reactant of the constituents.

As used herein, if (e.g., when) a definition is not otherwise provided, a particle diameter may be an average particle diameter. Such a particle diameter indicates an average particle diameter or size (D50) where a cumulative volume is about 50 volume % in a particle size distribution. The average particle diameter (D50) may be measured by any suitable method, for example, by a particle size analyzer, or by a transmission electron microscope (TEM) image, or a scanning electron microscope (SEM) image.

In one or more embodiments, a dynamic light-scattering measurement device is used to perform a data analysis, and the number of particles is counted for each particle size range, and from this, the average particle diameter (D50) value may be calculated. The particle size may be measured by a laser diffraction method.

The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

As used herein, the term “soft carbon” refers to graphitizable carbon materials that are readily graphitized by heat treatment at a high temperature, e.g., about 2800° C., and the term “hard carbon” refers to substantially non-graphitizable carbon materials that may only be slightly graphitized by heat treatment. The terms soft carbon and hard carbon are known in the related arts.

In one or more embodiments, the crystalline carbon and the amorphous carbon may be distinguished through X-ray diffraction (XRD) measurement. The crystalline carbon includes natural graphite and artificial graphite. Natural graphite may refer to graphite which may be naturally generated and obtained by separating it from minerals, and if measured by XRD, the interplanar spacing (d002) of the (002) plane may be about 3.350 Å to about 3.360 Å. Artificial graphite may refer to graphite manufactured by graphitization, and if (e.g., when) measured by XRD, the interplanar spacing (d002) of the (002) plane may be about 3.355 Å to about 3.365 Å. In one or more embodiments, the amorphous carbon may have the interplanar spacing (d 002) of the (002) plane of about 3.34 Å or less, if measured by XRD. The XRD may be measured using CuKα ray as a target ray with an X-ray diffraction analyzer (e.g., product name: X′Pert, manufacturer: Malvern Panalytical) and by removing a monochromator to improve a peak density resolution. The measurement condition may be 2θ=10° to 80°, a scan speed (°/S) of 0.044 to 0.089, and a step size (°/step) of 0.013 to 0.039.

A negative active material according to one or more embodiments has a peak intensity ratio (I₍₁₁₀₎/I₍₀₀₂₎) of a peak intensity at a (110) plane relative to a peak intensity at a (002) plane of about 30 to about 70, as measured by X-ray diffraction using a CuKα ray, and includes an aggregate where spherical artificial graphite and non-spherical artificial graphite are aggregated (e.g., agglomerated).

In one or more embodiments, the peak intensity ratio (I₍₁₁₀₎/I₍₀₀₂₎) of the negative active material may be about 30 to about 60, or about 30 to about 50. It may be difficult to prepare the negative active material with the peak intensity ratio (I₍₁₁₀₎/I₍₀₀₂₎) of less than about 30. If the peak intensity ratio (I₍₁₁₀₎/I₍₀₀₂₎) of the negative active material is more than about 70, the expansion and electrolyte impregnation characteristics may be degraded.

The peak intensity may be represented by a height of the peak or an integral area of the peak. In one or more embodiments, the peak intensity may be represented by the height of the peak.

In one or more embodiments, the XRD is measured by using a CuKα ray as a target ray and under a measurement condition of 2θ=10° to 80°, a scan speed (°/S) of 0.044 to 0.089, and a step size (°/step) of 0.013 to 0.039.

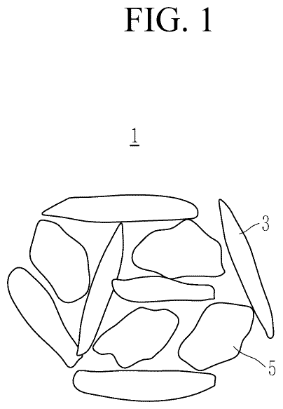

The aggregate where the spherical artificial graphite (e.g., particles) and the non-spherical artificial graphite (e.g., particles) are aggregated (e.g., agglomerated) is not a mixture in which the spherical artificial graphite and the non-spherical artificial graphite are merely physically mixed. The term “aggregate” as used herein refers to a negative active material 1 in which the spherical artificial graphite (e.g., particles) 5 is positioned between the non-spherical artificial graphite (e.g., particles) 3 to form an agglomerate and the non-spherical artificial graphite (e.g., particles) 3 is non-oriented, as shown in FIG. 1. For example, the orientation of each non-spherical artificial graphite particle 3 is random, and the non-spherical artificial graphite particles 3 are not oriented along any specific direction.

The inclusion of the non-spherical artificial graphite by non-orientating (e.g., in a state of random and no specific orientation) may improve the impregnability of the electrolyte of the negative active material.

If the spherical artificial graphite and the non-spherical artificial graphite are simply mixed, there may be areas where the non-spherical artificial graphite is aligned (e.g., the non-spherical artificial graphite particles are substantially aligned along a specific orientation), for example, there may be many areas where the non-spherical artificial graphite is aligned in line with the current collector (e.g., the non-spherical artificial graphite particles are aligned parallel or substantially parallel to the current collector). For example, the pressurizing act (task) during preparation of the negative electrode may cause the non-spherical artificial graphite particles to mainly present in a state of reclined in the longitudinal direction of the current collector, thereby exhibiting deteriorated electrolyte impregnability. That is, during the preparation of the negative electrode, the applying of pressure may cause non-spherical artificial graphite particles to align longitudinally along the current collector. Unfortunately, this alignment can lead to reduced electrolyte impregnability.

The simple mixture of the spherical artificial graphite and the non-spherical artificial graphite may be confirmed by an SEM image, as the shapes of the spherical artificial graphite and the non-spherical artificial graphite may be separately shown. However, if they are agglomerated into an aggregate, the spherical artificial graphite and the non-spherical artificial graphite may appear as an agglomerated shape of the spherical artificial graphite and the non-spherical artificial graphite in an SEM image and thus, the spherical shape and the non-spherical shape are not clearly distinguished. Thus, it may be seen that the simple mixture and the aggregate have different structures.

The negative active material according to one or more embodiments includes the aggregate where the spherical artificial graphite and the non-spherical artificial graphite are aggregated (e.g., agglomerated), thereby compensating the drawbacks of the spherical artificial graphite and the non-spherical artificial graphite with each other and obtaining a synergistic effect of the advantages or enhancements of the spherical artificial graphite and the non-spherical artificial graphite, and thus, excellent or suitable electrolyte impregnability, rate-capability, high capacity and high power characteristics may be realized.

The spherical artificial graphite may be artificial graphite having a substantially spherical shape. The substantially spherical shape may be a perfect sphere with a sphericity of 1, or an oval shape. The spherical artificial graphite may have an aspect ratio (length of long axis/length of short axis) of about 1 or more, and less than about 4, or about 1 to 2.

The non-spherical artificial graphite may be artificial graphite having any shape except for (i.e., other than) spherical shape, for example, may include a flake artificial graphite, and the flake artificial graphite may be or include plate-shaped graphite, rod-shaped artificial graphite, and/or a (e.g., any suitable) combination thereof. In one or more embodiments, the non-spherical artificial graphite may have an aspect ratio of about 4 or more.

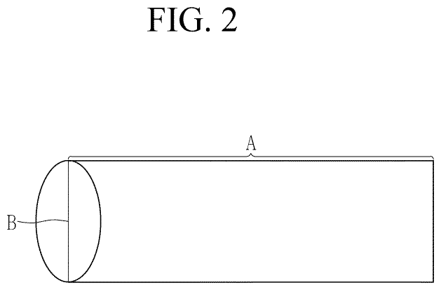

In one or more embodiments, the rod-shaped artificial graphite may have a maximum long diameter (length) of about 75 μm to about 160 μm. The maximum diameter refers to the length, and for example, it indicates a size of a long axis (A) among the long axis (A) and a short axis (B) of the rod-shaped (stick-shaped) artificial graphite shown in FIG. 2. In one or more embodiments, the long diameter may be the maximum long diameter.

The rod-shape refers to a shape that is substantially filled inside (e.g., has a solid interior) and elongated in the longitudinal direction, and is different from a shape with a hollow inside (e.g., a hollow interior), for example, a fiber shape (e.g., in a form of fibers) that is not filled inside. For example, the rod-shape may be a cylindrical-shape, a square cylinder-shape, and/or the like.

If the rod-shaped artificial graphite is included as the non-spherical artificial graphite, the denseness (e.g., packing density) of the negative active material layer may be reduced, thereby suppressing or reducing volume expansion which may occur during charging and the discharging, and the contact between the active materials may be enhanced to act as a lithium ion passage, thereby allowing the reduction in resistance.

Such a rod-shaped artificial graphite may have a length of about 75 μm to about 160 μm, about 80 μm to about 130 μm, or about 80 μm to about 120 μm. If the length of the rod-shaped artificial graphite is less than 75 μm, the resistance and the expansion may be increased, or the power characteristic may be deteriorated. In one or more embodiments, if the length is more than 160 μm, the size thereof may be too large, for example, larger than a thickness of the negative electrode, causing problems for production. To put it another way, if the length exceeds 160 μm, it may be too large, thereby causing production problems. In one or more embodiments, the length may be a maximum length.

The rod-shaped artificial graphite may have an aspect ratio of about 4 to about 30, or about 4 to about 20. In one or more embodiments, the aspect ratio may be an average aspect ratio. If the aspect ratio of the rod-shaped artificial graphite is within these ranges, the resistance may be reduced, the expansion may be suppressed or reduced, and the power characteristic may be improved.

In one or more embodiments, a mixing ratio of the spherical artificial graphite and the non-spherical artificial graphite may be about 10:90 to about 90:10 by weight ratio, about 20:80 to about 80:20 by weight ratio, about 50:50 to about 30:70 by weight ratio, about 70:30 to about 50:50 by weight ratio, or about 40:60 to about 60:40 by weight ratio. If the mixing ratio of the spherical artificial graphite and non-spherical artificial graphite satisfies these ranges, the orientation degree (e.g., of the non-spherical artificial graphite) may be reduced, thereby further enhancing electrolyte impregnation characteristics.

In one or more embodiments, a size ratio of the non-spherical artificial graphite and the spherical artificial graphite (non-spherical artificial graphite/spherical artificial graphite) may be about 0.5 to about 1.5, about 0.5 to about 1.0, or about 0.8 to about 1.2. The size of the non-spherical artificial graphite may represent (e.g., be) a length and the size of the spherical artificial graphite may represent (e.g., be) a particle diameter. The non-spherical artificial graphite and the spherical artificial graphite within these size ratio ranges may lead to easy aggregation or render to easily aggregate (e.g., may aggregate easily).

The aggregate according to one or more embodiments may be formed with an amorphous carbon layer or a metal compound layer on the surface thereof. For example, the negative active material according to one or more embodiments may include an aggregate and an amorphous carbon layer or a metal compound on the surface of the aggregate.

If the amorphous carbon layer or the metal compound layer is on the surface of the aggregate, the electrolyte impregnability may be more enhanced. For example, if the amorphous carbon layer is on the surface of the aggregate, the strength of the negative active material may be increased and the spring back may be increased after the pressurizing act in the negative electrode preparation using the negative active material, thereby enhancing the electrolyte impregnability. If the metal compound layer is on the surface of the aggregate, the hydrophilicity of the metal compound may improve the electrolyte impregnability.

In the amorphous carbon layer, the amorphous carbon may be soft carbon, hard carbon, mesophase pitch carbide, sintered coke, and/or a (e.g., any suitable) combination thereof.

In the metal compound layer, the metal compound may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof. For example, the metal compound may be a metal oxide.

In one or more embodiments, the amorphous carbon layer or the metal compound layer may have a thickness of about 0.1 μm to about 1 μm, about 0.3 μm to about 0.8 μm, or about 0.3 μm to about 0.5 μm. If the thickness of the amorphous carbon layer or the metal compound layer satisfies these ranges, suitable or better electrolyte impregnability may be exhibited.

If the negative active material further includes the amorphous carbon layer or the metal compound layer, an amount thereof may be, based on 100 wt % of the negative active material, about 0.01 wt % to about 0.1 wt %, about 0.01 wt % to about 0.05 wt %, or about 0.03 wt % to about 0.05 wt %. If the amount of the amorphous carbon layer or the metal compound layer is within these ranges, the electrolyte impregnation characteristic may be more enhanced.

An average particle diameter (D50) of the negative active material (e.g., in a form of particles (e.g., the aggerates having an amorphous carbon layer or a metal compound layer on the surface thereof)) according to one or more embodiments may be about 5 μm to about 25 μm, about 11 μm to about 14 μm, or about 12 μm to about 14 μm. If the average particle diameter (D50) of the negative active material is within these ranges, lithium input/output (e.g., intercalation/deintercalation) characteristic may be more enhanced, without the reduction in capacity.

The negative active material according to one or more embodiments may further include a binder pitch. The binder pitch may be a petroleum pitch, a coal pitch, meso pitch, pitch carbon, synthetic pitch, a synthetic resin, and/or a (e.g., any suitable) combination thereof. An amount of the binder pitch may be, based on 100 wt % of the negative active material, more than about 0 wt % and about 20 wt % or less, but the present disclosure is not limited thereto. For example, the amount of the binder pitch may be more than about 0 wt % and about 10 wt % or less, more than about 0 wt % and about 5 wt % or less, or more than about 0 wt % and about 3 wt % or less.

### Method of Preparing Negative Active Material

The negative active material according to one or more embodiments may be prepared by mixing a carbon precursor for a spherical artificial graphite and a non-spherical artificial graphite to form a mixture; aggregating the resulting mixture to prepare an aggregate; and graphitizing the aggregate.

A mixing ratio of the carbon precursor for the spherical artificial graphite and the non-spherical artificial graphite may be adjusted in order to have a mixing ratio of the spherical artificial graphite and the non-spherical artificial graphite to be about 10:90 to about 90:10 by weight ratio, about 20:80 to about 80:20 by weight ratio, or about 50:50 to about 30:70 by weight ratio.

The carbon precursor for the spherical artificial graphite may be petroleum cokes, petroleum pitch, coal pitch, meso pitch, pitch carbon, synthetic pitch, and/or a (e.g., any suitable) combination thereof.

The aggregating may be carried out by adding a binder pitch to the resulting mixture and heat-treating (e.g., to bind the spherical artificial graphite and the non-spherical artificial graphite together). The binder pitch may be petroleum pitch, coal pitch, meso pitch, pitch carbon, synthetic pitch, a synthetic resin, and/or a (e.g., any suitable) combination thereof. An amount of the binder pitch may be adjusted as long as it is sufficient to properly perform the aggregation (e.g., binding) process, and for example, it may be, based on 100 wt % of the resulting mixture and the binder pitch, more than about 0 wt % and about 20 wt % or less (e.g., greater than 0 wt % and at most about 20 wt %), or about 10 wt % or less (e.g., greater than 0 wt % and at most about 10 wt %). The heat treatment may be carried out at about 300° C. to about 600° C.

According the mixing and the aggregating, the carbon precursor (e.g., for the spherical artificial graphite) and the non-spherical artificial graphite may be conglomerated or agglomerated with each other to prepare a product in which the non-spherical artificial graphite is non-oriented.

The graphitization may be carried out at about 2800° C. to about 3100° C., for example, about 2900° C. to about 3000° C.

The graphitization may convert the carbon precursor for the spherical artificial graphite into a spherical artificial graphite to prepare an aggregate where the spherical artificial graphite and the non-spherical artificial graphite are aggregated (e.g., agglomerated) to prepare an aggregate as a negative active material. The non-spherical graphite presented at the non-oriented state in the mixing and the aggregating, may render to present the non-spherical artificial graphite in the prepared negative active material at a non-oriented state.

After the graphitization, an act of forming an amorphous carbon layer or a metal compound layer on the surface of the aggregate may be further performed. The forming process may be coating a coating liquid in which an amorphous carbon or a metal compound is dispersed in a solvent on the aggregate.

The solvent may be water, ethanol, methanol, and/or a (e.g., any suitable) combination thereof. The coating liquid may have a concentration of about 0.1 wt % to about 10 wt %, about 0.5 wt % to 2 wt %, or about 0.5 wt % to about 0.7 wt %. The concentration of the coating liquid within these ranges may suitably form the amorphous carbon layer or the metal compound layer on the surface of the aggregate.

The coating may be carried out by a spray coating or an immersion coating.

### Negative Electrode

A negative electrode according to one or more embodiments includes a negative active material layer and the negative active material layer includes a negative active material including an aggregate where a spherical artificial graphite and a non-spherical artificial graphite are aggregated (e.g., agglomerated).

In the measurement of the X-ray diffraction for the negative electrode using a CuKα ray, a peak intensity ratio (I₍₁₁₀₎/I₍₀₀₂₎) of a peak intensity at a (110) plane relative to a peak intensity at a (002) plane is about 200 to about 1000, or may be about 300 to about 1000, or about 300 to about 990.

If the peak intensity ratio (I₍₁₁₀₎/I₍₀₀₂₎) of the negative electrode is less than about 200, the pressurization may be undesirably performed and if it is more than about 1000, the expansion of the negative electrode may be (e.g., is) severe and the electrolyte may be not desirably impregnated.

The negative active material is the negative active material according to one or more embodiments. The negative electrode according to one or more embodiments includes the negative active material having the peak intensity ratio (I₍₁₁₀₎/I₍₀₀₂₎) of about 30 to about 70, and the peak intensity ratio (I₍₁₁₀₎/I₍₀₀₂₎) of the negative electrode prepared by using the negative active material is about 200 to about 1000.

In one or more embodiments, the negative active material layer may further include a binder and also may further include a conductive material (e.g., electron conductor).

For example, the negative active material layer may include the negative active material at about 90 wt % to about 99 wt % and the binder at about 1 wt % to about 10 wt %, or may include the negative active material at about 90 wt % to about 99 wt %, the binder at about 0.5 wt % to about 5 wt %, and the conductive material at about 0.5 wt % to about 5 wt %.

The binder may serve to attach the negative active material particles (e.g., well) to each other and also to attach the negative active material (e.g., well) to the current collector. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and/or a (e.g., any suitable) combination thereof.

If the aqueous binder is used as a negative electrode binder, a cellulose compound may be further used to provide viscosity as a thickener. The cellulose compound includes one or more of carboxymethyl cellulose, hydroxypropylmethyl cellulose, methyl cellulose, or alkali metal salts thereof. The alkali metal may be Na, K, or Li.

The dry binder may be a polymer material that is capable of being fibrous (e.g., in the form of a fiber), and for example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

The conductive material may be used to impart conductivity (e.g., electrical or electron conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, ketjen black, a carbon fiber, a carbon nanofiber, and/or a carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

The negative electrode according to one or more embodiments includes a current collector supporting the negative active material layer. The current collector may include a copper foil, a nickel foil, a stainless steel foil, a titanium foil, a nickel foam, a copper foam, a polymer substrate coated with a conductive metal, and/or a (e.g., any suitable) combination thereof.

### Rechargeable Lithium Battery

According to one or more embodiments, a rechargeable lithium battery includes the negative electrode, a positive electrode, and an electrolyte.

### Positive Electrode

The positive electrode may include a current collector and a positive active material layer on the current collector.

The positive active material layer may include a positive active material and may further include a binder and/or a conductive material (e.g., an electrically or electron conductive material (e.g., electron conductor)).

For example, the positive electrode may further include an additive that may serve as a sacrificial positive electrode.

An amount of the positive active material may be about 90 wt % to about 99.5 wt % based on 100 wt % of the positive active material layer and amounts of the binder and the conductive material may be about 0.5 wt % to about 5 wt % based on 100 wt % of the positive active material layer, respectively.

The binder serves to attach the positive active material particles (e.g., well) to each other and also to attach the positive active material (e.g., well) to the current collector. Non-limiting examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like.

The conductive material may be used to impart conductivity (e.g., electrical or electron conductivity) to the electrode, and any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and/or carbon nanotube; a metal-based material containing copper, nickel, aluminum, silver, and/or the like, in a form of a metal powder or a metal fiber; a conductive polymer such as a polyphenylene derivative; and/or a (e.g., any suitable) mixture thereof.

Al (aluminum) may be used as the current collector, but the present disclosure is not limited thereto.

### Electrolyte

The electrolyte for a rechargeable lithium battery includes a non-aqueous organic solvent and a lithium salt.

The non-aqueous organic solvent may serve as a medium for transmitting (e.g., transporting or conducting) ions taking part in the electrochemical reaction of a battery.

The non-aqueous organic solvent may be a carbonate-based, ester-based, ether-based, ketone-based, or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone, and/or the like. The alcohol-based solvent may include ethanol, isopropyl alcohol, and/or the like and the aprotic solvent may include nitriles such as R-CN (wherein R is a C2 to C20 linear, branched, or cyclic hydrocarbon group, and may include a double bond, an aromatic ring, or an ether bond, and/or the like); amides such as dimethylformamide; dioxolanes such as 1,3-dioxolane, 1,4-dioxolane, and/or the like; sulfolanes, and/or the like.

The non-aqueous organic solvents may be used alone or in combination of two or more.

If using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between the positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), wherein x and y are each independently integers of 1 to 20, lithium trifluoromethane sulfonate, lithium tetrafluoroethersulfonate, lithium difluorobis(oxalato)phosphate (LiDFBOP), and lithium bis(oxalato) borate (LiBOB).

### Separator

Depending on the type or kind of the rechargeable lithium battery, a separator may be present between the positive electrode and the negative electrode. The separator may include polyethylene, polypropylene, polyvinylidene fluoride, a multilayer film of two or more layers thereof, and/or a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on a surface (e.g., one or both surfaces (e.g., opposite surfaces)) of the porous substrate.

The porous substrate may be a polymer film formed of any one selected from among polyolefin such as polyethylene and/or polypropylene, polyester such as polyethylene terephthalate and/or polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or mixture of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

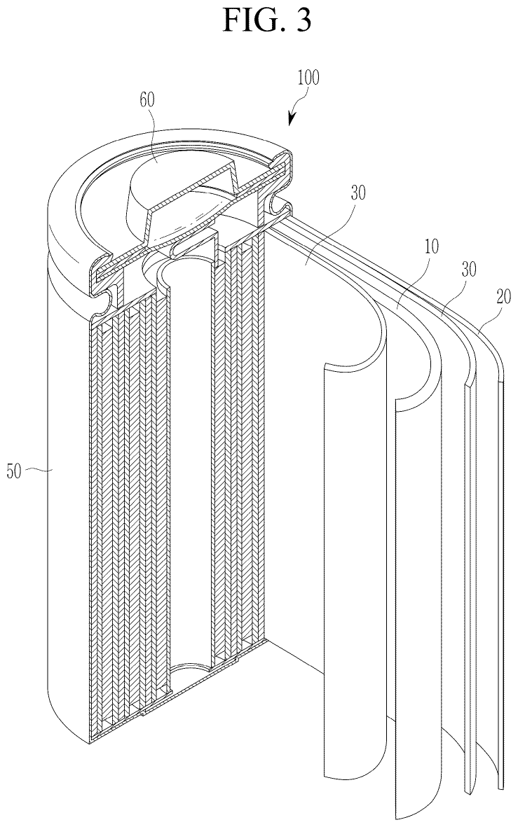

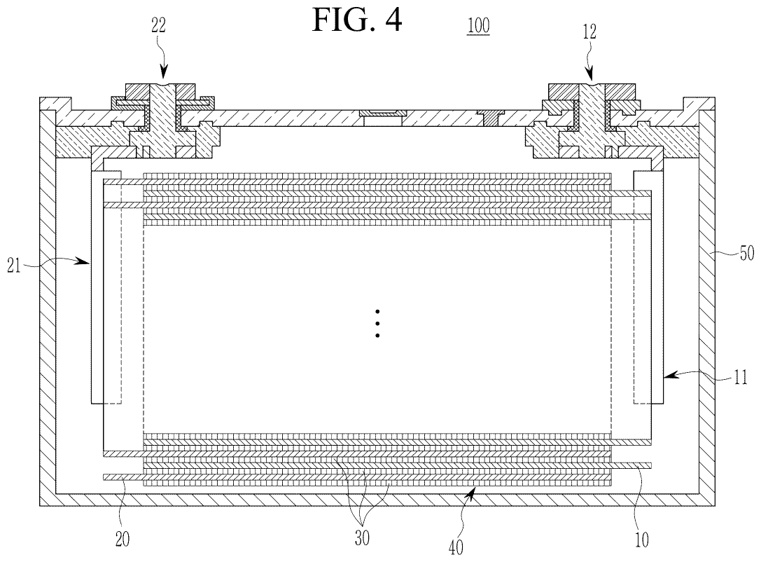

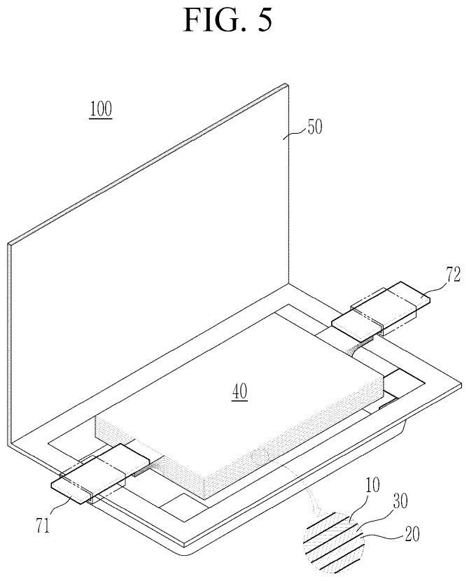

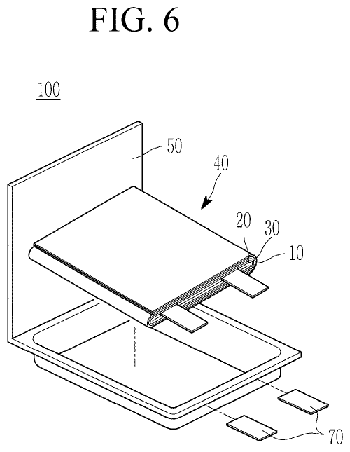

The rechargeable lithium battery may be classified into cylindrical, prismatic, pouch, or coin-type or kind batteries, and/or the like depending on their shape. FIG. 3 to FIG. 6 are schematic views illustrating a rechargeable lithium battery according to one or more embodiments. FIG. 3 shows a cylindrical battery, FIG. 4 shows a prismatic battery, and FIG. 5 and FIG. 6 show pouch-type or kind batteries. Referring to FIG. 3 to FIG. 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 3. In FIG. 4, the rechargeable lithium battery 100 may include a positive lead tab 11, a positive terminal 12, a negative lead tab 21, and a negative terminal 22. As shown in FIG. 5 and FIG. 6, the rechargeable lithium battery 100 may include an electrode tab 70, which may be, for example, a positive electrode tab 71 and a negative electrode tab 72 serving as an electrical path for inducing the current formed in the electrode assembly 40 to the outside.

Hereinafter, examples of the present disclosure and comparative examples are described. These examples, however, are not in any sense to be interpreted as limiting the scope of the present disclosure.

### Example 1

Petroleum cokes with an aspect ratio of 1.2 and a rod-shaped artificial graphite with a maximum length of 80 μm and an average aspect ratio of 5 to 10 were mixed at a weight ratio of 50:50, and the mixture was subjected to an aggregation process in which the mixture at 97 wt % was added (e.g., mixed) with a coal pitch as a binder pitch at 3 wt %, and then heat-treated at 500° C., thereby preparing an aggregate.

The aggregate was heat-treated at 3000° C. to convert the petroleum cokes into artificial graphite with an aspect ratio of 1.2 and to prepare a negative active material in which a spherical artificial graphite and a non-spherical artificial graphite were aggregated (e.g., agglomerated) to prepare an aggregate (amount of binder pitch: 2 wt %), i.e., a negative active material.

96 wt % of the negative active material, 3 wt % of a styrene butadiene rubber, and 1 wt % of carboxymethyl cellulose were mixed in a water solvent to prepare a negative active material slurry.

The negative active material slurry was coated on a Cu foil current collector, dried, and pressurized by the general procedure to prepare a negative electrode including a current collector and a negative active material layer on the current collector.

Using the negative electrode, a lithium metal counter electrode, and an electrolyte, a rechargeable lithium cell was fabricated. The electrolyte was used 1.5 M LiPF₆ dissolved in a mixed solvent of ethylene carbonate, ethyl methyl carbonate, and dimethyl carbonate (20:10:70 volume ratio).

### Example 2

A negative active material was prepared by the same procedure as in Example 1, except the petroleum coke and a rod-shaped artificial graphite were mixed at a weight ratio of 70:30.

The negative active material was used to fabricate a negative electrode and a coin-type or kind half-cell by the same procedure as in Example 1.

### Example 3

A negative active material was prepared by the same procedure as in Example 1, except the petroleum cokes and the rod-shaped artificial graphite were mixed at a weight ratio of 30:70.

The negative active material was used to fabricate a negative electrode and a coin-type or kind half-cell by the same procedure as in Example 1.

### Example 4

Al₂O₃ was added to ethanol as a solvent to prepare a metal oxide liquid (dispersion) with a solid amount of 0.5 wt %.

The aggregate where the spherical artificial graphite and the rod-shaped artificial graphite were aggregated (e.g., agglomerated), prepared in Example 1 was coated with the metal oxide liquid and dried to prepare a negative active material in which Al₂O₃ coating layer with a 0.5 μm thickness was formed on the surface of the aggregate. An amount of the metal oxide was 0.05 wt % based on 100 wt % of the negative active material.

The negative active material was used to fabricate a negative electrode and a coin-type or kind half-cell by the same procedure as in Example 1.

### Example 5

A negative active material was prepared by the same procedure as in Example 4, except the petroleum cokes and the rod-shaped artificial graphite were mixed at a weight ratio of 70:30.

The negative active material was used to fabricate a negative electrode and a coin-type or kind half-cell by the same procedure as in Example 1.

### Example 6

A negative active material was prepared by the same procedure as in Example 4, except the petroleum cokes and a rod-shaped artificial graphite were mixed at a weight ratio of 30:70.

The negative active material was used to fabricate a negative electrode and a coin-type or kind half-cell by the same procedure as in Example 1.

### Comparative Example 1

Petroleum cokes was heat-treated at 3000° C. to prepare a spherical artificial graphite used as a negative active material.

The negative active material was used to fabricate a negative electrode and a coin-type or kind half-cell by the same procedure as in Example 1.

### Comparative Example 2

A rod-shaped artificial graphite with a maximum length of 80 μm and an average aspect ratio of 5 to 10 was used as a negative active material.

The negative active material was used to fabricate a negative electrode and a coin-type or kind half-cell by the same procedure as in Example 1.

### Comparative Example 3

Petroleum cokes was heat-treated at 3000° C. to prepare a spherical artificial graphite used as a negative active material.

The spherical artificial graphite was mixed with a rod-shaped artificial graphite with a maximum length of 80 μm and an average aspect ratio of 5 to 10 at a weight ratio of 50:50 to prepare a negative active material.

The negative active material was used to fabricate a negative electrode and a coin-type or kind half-cell by the same procedure as in Example 1.

### Comparative Example 4

Petroleum cokes was heat-treated at 3000° C. to prepare a spherical artificial graphite used as a negative active material.

The spherical artificial graphite was mixed with a rod-shaped artificial graphite with a maximum length of 80 μm and an average aspect ratio of 5 to 10 at a weight ratio of 70:30 to prepare a negative active material.

The negative active material was used to fabricate a negative electrode and a coin-type or kind half-cell by the same procedure as in Example 1.

### Comparative Example 5

Petroleum cokes was heat-treated at 3000° C. to prepare a spherical artificial graphite used as a negative active material.

The spherical artificial graphite was mixed with a rod-shaped artificial graphite with a maximum length of 80 μm and an average aspect ratio of 5 to 10 at a weight ratio of 30:70 to prepare a negative active material.

A negative electrode and a half-cell were fabricated by the same procedure as in Example 1, except for using the negative active material.

### Comparative Example 6

Petroleum cokes was heat-treated at 3000° C. to prepare a spherical artificial graphite used as a negative active material.

The spherical artificial graphite was mixed with a rod-shaped artificial graphite with a maximum length of 80 μm and an average aspect ratio of 5 to 10 at a weight ratio of 80:20 to prepare a negative active material.

The negative active material was used to fabricate a negative electrode and a coin-type or kind half-cell by the same procedure as in Example 1.

### Experimental Example 1) SEM Image

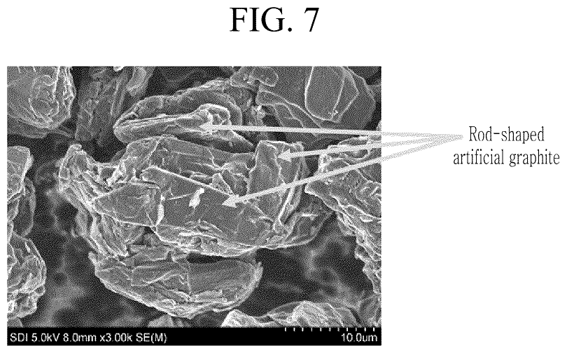

The SEM image of the negative active material prepared in Example 1 is shown in FIG. 7. It can be seen from FIG. 7 that the negative active material prepared according to Example 1 had an aggregate where the spherical artificial graphite and the rod-shaped artificial graphite were aggregated (e.g., agglomerated).

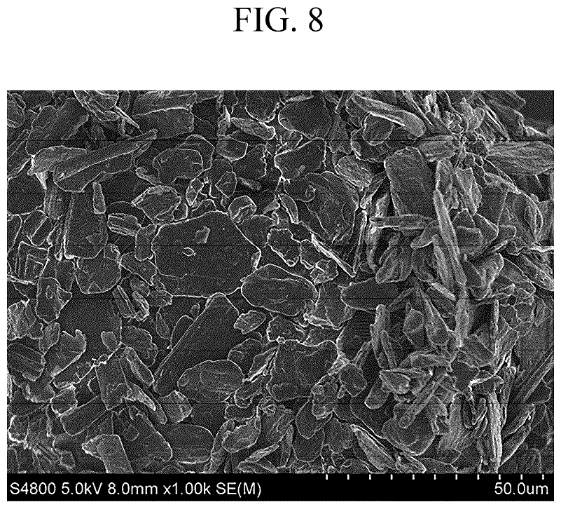

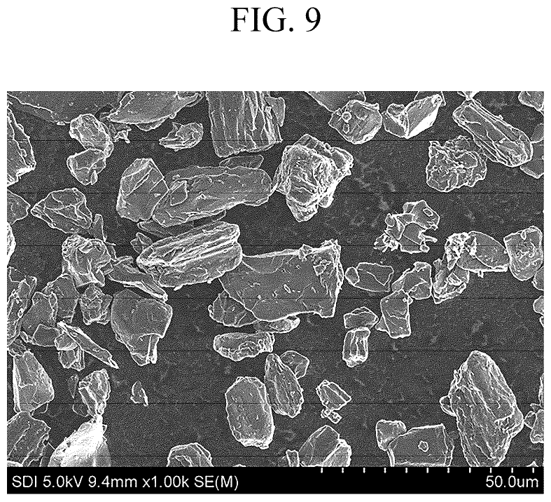

The SEM image of FIG. 7 is different from the SEM image shown in FIG. 8 of Comparative Example 2 that only used the rod-shaped artificial graphite and the SEM image shown in FIG. 9 of Comparative Example 1 that only used the spherical artificial graphite.

### Experimental Example 2) Physical Properties of Negative Active Material

The average particle diameter (D50) of the negative active materials according to Examples 1 to 6 and Comparative Examples 1 to 6 were measured by using a particle size analyzer. The results are shown in Table 1.

1 g of the negative active materials according to Examples 1 to 6 and Comparative Examples 1 to 6 was put into a mold and it was maintained under a pressure (press force) of 2 ton for 30 seconds to prepare a pellet. A density was obtained from the thickness and the area of the pellet. The results are shown in Table 1.

### Experimental Example 3) Evaluation of Electrolyte Impregnation

96 wt % of the negative active material according to Examples 1 to 6 and Comparative Examples 1 to 6, 3 wt % of a styrene butadiene rubber, and 1 wt % of carboxymethyl cellulose were mixed in water as a solvent to prepare a negative active material slurry. The negative active material slurry was dried for 24 hours to prepare a negative active material slurry powder. 1 g of the prepared negative active material slurry powder was put into a mold and a pressure was applied thereto, thereby preparing a pellet of 1.5 g/cc. An electrolyte was dropped onto the pellet to measure the time until the electrolyte was completely impregnated.

The electrolyte was prepared by dissolving 1.5 M LiPF₆ in ethylene carbonate, ethylmethyl carbonate, and dimethyl carbonate (30:50:20 by volume ratio).

The results are shown in Table 1, as impregnation time.

### Experimental Example 4) Measurement of Peak Intensity Ratio

Regarding the negative active materials and the negative electrodes according to Examples 1 to 6 and Comparative Examples 1 to 6, X-ray diffraction peak intensities were measured by using a CuKα ray.

The measurement conditions were set to 2Θ=10° to 80°, scan speed (°/S) of 0.044, and step size (°/step) of 0.013°/step.

The results are shown in Table 1.

### Experimental Example 5) Evaluation of Capacity

The half-cells according to Examples 1 to 6 and Comparative Examples 1 to 6 were once charged and discharged at 0.1 C, and once charged and discharged at 0.2 C to measure a charge capacity at 0.2 C. The results are shown in Table 2.

### Experimental Example 6) Evaluation of Charge and Discharge Efficiency

The half-cells according to Examples 1 to 6 and Comparative Examples 1 to 6 were once charged and discharged at 0.1 C to measure charge and discharge capacities. A ratio of the discharge capacity relative to the charge capacity was calculated. The results are shown in Table 2, as efficiency.

### Experimental Example 7) Evaluation of Chargeability

The half-cells according to Examples 1 to 6 and Comparative Examples 1 to 6 were once charged and discharged at 0.2 C and once charged and discharged at 2.0 C. A ratio of CC-charge capacity at 2.0 C relative to CC-charge capacity at 0.2 C was calculated. The results are shown in Table 2, as chargeability.

TABLE 1

| | | Pellet | | Peak intensity ratio | Peak intensity ratio |
|---|---|---|---|---|---|
| | D50 | density | Impregnation | (I₍₁₁₀₎/I₍₀₀₂₎) (negative | (I₍₁₁₀₎/I₍₀₀₂₎) (active |
| | (μm) | (g/cc) | time (s) | electrode) | material) |
| Example 1 | 20 | 1.70 | 5 | 307 | 37 |
| Example 2 | 17 | 1.60 | 5 | 985 | 33 |
| Example 3 | 20 | 1.75 | 7 | 672 | 41 |
| Example 4 | 20 | 1.70 | 4 | 415 | 39 |
| Example 5 | 17 | 1.60 | 4 | 758 | 35 |
| Example 6 | 20 | 1.75 | 6 | 367 | 42 |
| Comparative | 17 | 1.55 | 8 | 161 | 65 |
| Example 1 | | | | | |
| Comparative | 18 | 1.85 | 18 | 152 | 152 |
| Example 2 | | | | | |
| Comparative | 18 | 1.70 | 10 | 173 | 111 |
| Example 3 | | | | | |
| Comparative | 17 | 1.60 | 9 | 163 | 91 |
| Example 4 | | | | | |
| Comparative | 18 | 1.65 | 14 | 156 | 125 |
| Example 5 | | | | | |
| Comparative | 17 | 1.58 | 9 | 169 | 81 |
| Example 6 | | | | | |

TABLE 2

| | Capacity (mAh/g) | Efficiency (%) | Chargeability (%) |
|---|---|---|---|
| Example 1 | 346 | 91 | 45 |
| Example 2 | 350 | 92 | 47 |
| Example 3 | 344 | 91 | 44 |
| Example 4 | 345 | 91 | 47 |
| Example 5 | 348 | 92 | 49 |
| Example 6 | 343 | 91 | 46 |
| Comparative Example 1 | 340 | 93 | 41 |
| Comparative Example 2 | 351 | 90 | 30 |
| Comparative Example 3 | 345 | 91 | 36 |
| Comparative Example 4 | 343 | 92 | 38 |
| Comparative Example 5 | 346 | 91 | 33 |
| Comparative Example 6 | 342 | 92 | 40 |

As shown in Table 1, the X-ray diffraction result of the negative active materials according to Examples 1 to 6 each exhibited the peak intensity ratio (I₍₁₁₀₎/I₍₀₀₂₎) of 30 to 70 and the peak intensity ratio (I₍₁₁₀₎/I₍₀₀₂₎) of the respective negative electrode was in the range of 200 to 1000. The electrolyte impregnation time of each of Examples 1 to 6 was 4 seconds to 7 seconds, showing better electrolyte impregnability compared to Comparative Examples.

The cells including the negative active materials of Examples 1 to 6 each exhibited similar efficiency to Comparative Examples 1 to 6, but slightly higher capacity, and better chargeability than Comparative Examples 1 to 6.

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Here, unless otherwise defined, the listing of steps, tasks, or acts in a particular order should not necessarily means that the invention or claims require that particular order. That is, the general rule that unless the steps, tasks, or acts of a method (e.g., a method claim) actually recite an order, the steps, tasks, or acts should not be construed to require one.

Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively.

Descriptions of features or aspects within each embodiment should typically be considered as available for other similar features or aspects in other embodiments.

In the present disclosure, when particles are spherical, “diameter” indicates a particle diameter or an average particle diameter, and when the particles are non-spherical, the “diameter” indicates a major axis length or an average major axis length. A battery forming or manufacturing system, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this disclosure has been described in connection with what is presently considered to be practical example embodiments, it is to be understood that present disclosure is not limited to the disclosed embodiments, but, on the contrary, is intended to cover one or more suitable modifications and equivalent arrangements included within the spirit and scope of the appended claims, and equivalents thereof.

What is claimed is:

1. A negative active material, comprising
an aggregate where spherical artificial graphite and non-spherical artificial graphite are aggregated,
wherein the negative active material has a peak intensity ratio (I₍₁₁₀₎/I₍₀₀₂₎) of a peak intensity at a (110) plane relative to a peak intensity at a (002) plane of about 30 to about 70, as measured by X-ray diffraction utilizing a CuKα ray.

2. The negative active material as claimed in claim 1, wherein the non-spherical artificial graphite comprises a flake artificial graphite.

3. The negative active material as claimed in claim 2, wherein the flake artificial graphite comprises plate-shaped graphite, rod-shaped artificial graphite, or a combination thereof.

4. The negative active material as claimed in claim 3, wherein the rod-shaped artificial graphite has a maximum length of about 75 μm to about 160 μm.

5. The negative active material as claimed in claim 3, wherein the rod-shaped artificial graphite has an aspect ratio of about 4 to about 30.

6. The negative active material as claimed in claim 1, wherein a mixing ratio of the spherical artificial graphite and the non-spherical artificial graphite is about 10:90 to about 90:10 by a weight ratio.

7. The negative active material as claimed in claim 1, further comprising
an amorphous carbon layer or a metal compound layer,
on a surface of the aggregate.

8. The negative active material as claimed in claim 7, the amorphous carbon layer is on the surface of the aggregate, and wherein the amorphous carbon layer comprises soft carbon, hard carbon, mesophase pitch carbide, sintered coke, or a combination thereof.

9. The negative active material as claimed in claim 7, wherein the metal compound layer is on the surface of the aggregate, and wherein the metal compound layer comprises Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, boehmite, or a combination thereof.

10. The negative active material as claimed in claim 7, wherein the amorphous carbon layer or the metal compound layer has a thickness of about 0.1 μm to about 1 μm.

11. The negative active material as claimed in claim 1, wherein the negative active material is in a form of particles and the particles have an average particle diameter (D50) of about 5 μm to about 25 μm.

12. A negative electrode comprising:
a negative active material layer, the negative active material layer comprising an aggregate where spherical artificial graphite and non-spherical artificial graphite are aggregated,
wherein the negative electrode has a peak intensity ratio (I₍₁₁₀₎/I₍₀₀₂₎) of a peak intensity at a (110) plane relative to a peak intensity at a (002) plane of about 200 to about 1000, as measured by an X-ray diffraction utilizing CuKα ray.

13. The negative electrode as claimed in claim 12, wherein a mixing ratio of the spherical artificial graphite and the non-spherical artificial graphite is about 10:90 to about 90:10 by a weight ratio.

14. The negative electrode as claimed in claim 12, further comprising
an amorphous carbon layer or a metal compound layer,
on a surface of the aggregate.

15. The negative electrode as claimed in claim 12, wherein the non-spherical artificial graphite comprises a flake-shaped artificial graphite.

16. A method comprising:
mixing a carbon precursor for a spherical artificial graphite and non-spherical artificial graphite to form a mixture,
aggregating the mixture to form an aggregate; and
graphitizing the aggregate,
wherein the method is a method of preparing a negative active material.

17. The method as claimed in claim 16, wherein the carbon precursor for the spherical artificial graphite comprises petroleum coke, coal coke, petroleum pitch, coal pitch, meso pitch, pitch carbon, synthetic pitch, a synthetic resin, or a combination thereof.

18. The method as claimed in claim 16, wherein the graphitizing is carried out by heat-treating at about 2800° C. to about 3100° C.

19. A rechargeable lithium battery, comprising:
a negative electrode comprising the negative active material as claimed in claim 1;
a positive electrode; and
an electrolyte.

20. A rechargeable lithium battery, comprising:
the negative electrode as claimed in claim 12;
a positive electrode; and
an electrolyte.
